(19) United States
(12) Patent Application Publication
(10) Pub. No.: US 2026/0115850 A1
(43) Pub. Date: Apr. 30, 2026

(54) MACHINE TOOL

(71) Applicant: DMG MORI CO., LTD., Nara (JP)

(72) Inventor: Takahiro NISHIKI, Nara (JP)

(73) Assignee: DMG MORI CO., LTD., Nara (JP)

(21) Appl. No.: 18/693,454

(22) PCT Filed: Sep. 21, 2021
(86) PCT No.: PCT/JP2021/034491

§ 371 Date: Mar. 19, 2024

(51) Int. Cl. B23Q 15/12

(52) U.S. Cl. CPC B23Q 15/12

(57) ABSTRACT

A controller of a machine tool checks data on the inertia of a rotary body when rotating the rotary body in accordance with a machining program. When the data on the inertia of the rotary body has been set, the controller checks whether or not a rotation speed of the rotary body specified by the machining program is equal to or lower than a limit rotation speed set according to the inertia of the rotary body When the rotation speed of the rotary body specified by the machining program exceeds the limit rotation speed, the controller limits the rotation speed of the rotary body specified by the machining program using as an allowable rotation speed a preset rotation speed equal to or lower than the limit rotation speed.

### TECHNICAL FIELD

The present invention relates to a machine tool that has a motion mechanism unit including a rotary body and has a controller controlling at least a rotating operation of the rotary body in accordance with a machining program.

### BACKGROUND ART

In the field of machine tools, a motor is used to rotate a workpiece or a tool that is a rotary body. Such a motor is connected to the rotary body to drive the rotary body. The operation of the motor is controlled by a controller.

Such a machine tool conventionally includes a circuit called “dynamic braking circuit” that is used to carry out emergency stopping of the motor when the motor rotating becomes uncontrollable due to power outage or any other cause. Japanese U.S. Pat. No. 6,285,477 (Patent Literature 1 listed below) discloses a motor driving device that is a known conventional example of a device including such a dynamic braking circuit.

The disclosed motor driving device consists of: an inverter driving a motor; a rotation speed obtaining unit obtaining a rotation speed of the motor; an inertia information storage storing information on the inertia of the motor; a rotational energy calculating unit calculating a rotational energy of the motor based on the rotation speed and inertia of the motor; a dynamic braking circuit generating a deceleration torque through dynamic braking of the motor in emergency stopping of the motor; a tolerance information storage storing information on the tolerance of a resistance in the dynamic braking circuit; a power element operating unit turning on a power element of one of upper and lower arms and turning off a power element of the other of the upper and lower arms in the emergency stopping of the motor; a dynamic braking circuit operating unit operating a switch of the dynamic braking circuit; and a tolerance comparing unit comparing the rotational energy of the motor with the tolerance of the dynamic braking circuit.

The dynamic braking circuit operating unit actuates the dynamic braking circuit when the rotational energy of the motor does not exceed the tolerance of the dynamic braking circuit, while the dynamic braking circuit operating unit does not actuate the dynamic braking circuit when the rotational energy of the motor exceeds the tolerance of the dynamic braking circuit. When the rotational energy of the motor exceeds the tolerance of the dynamic braking circuit, the dynamic braking circuit operating unit causes the motor to idle for a while. Thereby, the rotation speed of the motor is reduced. After the rotational energy of the motor reaches or falls below the tolerance of the dynamic braking circuit, the dynamic braking circuit operating unit actuates the dynamic braking circuit.

Thus, this conventional motor driving device avoids damage to the dynamic braking circuit through the dynamic braking circuit operating unit that operates in the above-described manner.

### CITATION LIST

### Patent Literature

Patent Literature 1: Japanese U.S. Pat. No. 6,285,477

### SUMMARY OF INVENTION

### Technical Problem

As described above, in the event that the motor in operation becomes uncontrollable due to power outage or any other cause, this conventional motor driving device is configured to carry out emergency stopping of the motor as follows: when the rotational energy of the motor does not exceed the tolerance of the emergency stop circuit, the motor driving device stops the motor through the emergency stop circuit; and when the rotational energy of the motor exceeds the tolerance of the emergency stop circuit, the motor driving device actuates the emergency stop circuit after reducing the rotational energy of the motor to the tolerance of the emergency stop circuit or less by causing the motor to idle for a while.

When the rotation speed of the motor is set at a high speed, there is the concern as described above, that is to say, the rotation speed of the motor may exceed the tolerance of the emergency stop circuit operating in the emergency stopping. Besides this concern, if the rotary body has a large inertia, a large load is applied to the motor in accelerating and decelerating the rotary body. This is not preferable.

Machining in an NC machine tool uses an NC program. This NC program is created by an operator or automatically created by an automatic programming device. In the creation, the rotation speed of the motor used for the tool spindle or the workpiece spindle is determined based on various factors related to the machining conditions, such as tool material, workpiece material, and machining accuracy; however, the inertia of the rotary body including the motor has not been taken into consideration.

Accordingly, a conventional machine tool has the possibility that a rotation speed of the motor set in machining exceeds the tolerance of the emergency stop circuit for emergency stopping of the motor; therefore, the measures as described above need to be taken.

The present invention has been achieved in view of the above-described circumstances, and an object of the invention is to provide a machine tool capable of performing machining with a motor at a rotation speed not exceeding an allowable rotation speed corresponding to the inertia of a rotary body, even when a rotation speed of the motor commanded by an NC program exceeds the allowable rotation speed.

### Solution to Problem

To solve the above-described problem, the present invention provides a machine tool including:
a motion mechanism unit that includes a rotary body to be controlled; and
a controller that controls at least a rotating operation of the rotary body in accordance with a machining program, wherein
the controller is configured to: check data on an inertia of the rotary body when rotating the rotary body in accordance with the machining program; when the data on the inertia of the rotary body has been set, check whether or not a rotation speed of the rotary body specified by the machining program is equal to or lower than a limit rotation speed set according to the inertia of the rotary body; and when the rotation speed of the rotary body specified by the machining program exceeds the limit rotation speed, limit the rotation speed of the rotary body specified by the machining program using as an allowable rotation speed a preset rotation speed equal to or lower than the limit rotation speed.

In the machine tool according to the present invention, the controller checks data on the inertia of the rotary body when rotating the rotary body in accordance with a machining program. For example, the controller checks the data on the inertia of the rotary body by referring to a storage provided to store the data. When the data on the inertia of the rotary body has been set, the controller checks whether or not a rotation speed of the rotary body specified by the machining program is equal to or lower than a limit rotation speed that is set according to the inertia of the rotary body. When the rotation speed of the rotary body specified by the machining program exceeds the limit rotation speed, the controller limits the rotation speed of the rotary body specified by the machining program using as an allowable rotation speed a preset rotation speed equal to or lower than the limit rotation speed.

Thus, the machine tool according to the present invention is configured such that, when a rotation speed of the rotary body specified by the machining program exceeds the limit rotation speed that is set according to the inertia of the rotary body, the rotation speed of the rotary body is limited to the allowable rotation speed that is equal to or lower than the limit rotation speed. Consequently, a motor driving the rotary body is safely stopped by an appropriately provided emergency stop device in the event that the motor becomes uncontrollable due to power outage or any other cause. Besides, excessive loading on the motor in driving and stopping the rotary body is avoided.

Note that the rotary body includes the motor, a workpiece to be rotated by the motor, and other jigs.

The machine tool may be configured according to the following aspect: the controller is configured to: confirm whether or not an operator accepts the allowable rotation speed; when the operator accepts the allowable rotation speed, continue machining by limiting the rotation speed of the rotary body specified by the machining program to the allowable rotation speed; and when the operator does not accept the allowable rotation speed, stop the machining.

Performing the machining with the allowable rotation speed may not achieve a required machining accuracy, such as in surface roughness. Therefore, confirming with the operator whether or not the machining can be performed with the allowable rotation speed will prevent a machined product from being defective.

The machine tool may be configured according to the following aspect: the controller is configured to, when the data on the inertia of the rotary body has not been set or when the set data on the inertia of the rotary body is determined to be an abnormal value, limit the rotation speed of the rotary body specified by the machining program to a preset safe rotation speed.

When the inertia of the rotary body has not been set or when the inertia of the rotary body has been set but the data on the inertia is determined to be an abnormal value, the limit rotation speed for the rotary body cannot be recognized. Therefore, it is not possible to determine whether or not the rotation speed of the rotary body specified by the machining program is an appropriate rotation speed which allows the emergency stopping to be performed.

In such a case, limiting the rotation speed of the rotary body to the safe rotation speed that has a sufficient margin such that the motor driving the rotary body is safely stopped by the appropriately provided emergency stop device in the event that the motor becomes uncontrollable due to power outage or any other cause will allow the emergency stopping of the rotary body to be safely carried out. Besides, excessive loading on the motor in driving and stopping the rotary body is avoided.

In this aspect, the controller may be configured to: confirm whether or not the operator accepts the safe rotation speed; when the operator accepts the safe rotation speed, continue the machining by limiting the rotation speed of the rotary body specified by the machining program to the safe rotation speed; and when the operator does not accept the safe rotation speed, stop the machining.

As described above, the rotation speed is a factor affecting the machining accuracy such as surface roughness. Therefore, confirming with the operator whether or not the machining can be performed with the safe rotation speed will prevent a machined product from be defective.

Further, the controller may be configured to be capable of newly setting the data on the inertia of the rotary body when the data on the inertia of the rotary body has not been set or when the set data on the inertia of the rotary body is determined to be an abnormal value. Furthermore, the controller may be configured to calculate and set the data on the inertia of the rotary body by causing the rotary body to perform the rotating operation and a stopping operation. This configuration enables the inertia of the rotary body to be accurately and automatically set.

### Advantageous Effects of Invention

In the present invention, as described above, when a rotation speed of the rotary body specified by the machining program exceeds the limit rotation speed that is set according to the inertia of the rotary body, the rotation speed of the rotary body is limited to the allowable rotation speed that is equal to or lower than the limit rotation speed. Consequently, a motor driving the rotary body is safely stopped by an appropriately provided emergency stop device in the event that the motor becomes uncontrollable due to power outage or any other cause. Besides, excessive loading on the motor in driving and stopping the rotary body is avoided.

On the other hand, when the data on the inertia of the rotary body has not been set or when the set data on the inertia of the rotary body is determined to be an abnormal value, the rotation speed of the rotary body is limited to the safe rotation speed that has a sufficient margin such that the motor driving the rotary body is safely stopped by the appropriately provided emergency stop device in the event that the motor becomes uncontrollable due to power outage or any other cause. Consequently, the emergency stopping of the rotary body is safely carried out. Besides, excessive loading on the motor in driving and stopping the rotary body is avoided.

### BRIEF DESCRIPTION OF DRAWINGS

FIG. 1 is an illustrative diagram schematically illustrating a structure of a machine tool according to an embodiment of the present invention;

FIG. 2 is a block diagram schematically illustrating a configuration of the machine tool according to the embodiment;

FIG. 3 is a flowchart showing a process in a controller in the embodiment;

FIG. 4 is a flowchart showing the process in the controller in the embodiment;

FIG. 5 is a circuit diagram showing a motor circuit including an emergency stop circuit provided in a rotation control unit in the embodiment; and

FIG. 6 is a diagram showing a relationship between inertia and rotation speed for carrying out emergency stopping of a rotary body within a predetermined period of time.

### DESCRIPTION OF EMBODIMENTS

Hereinafter, a specific embodiment of the present invention will be described with reference to the drawings.

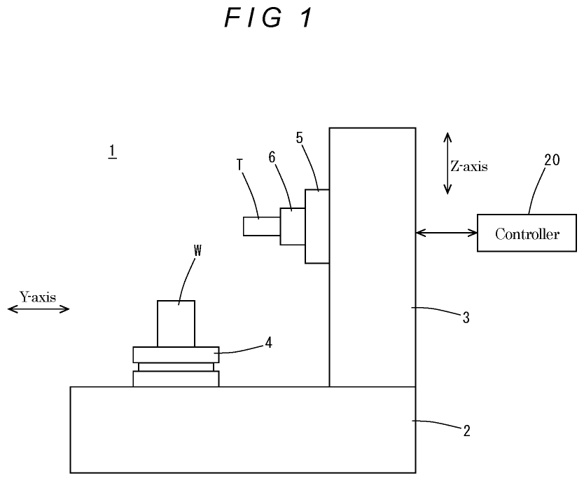

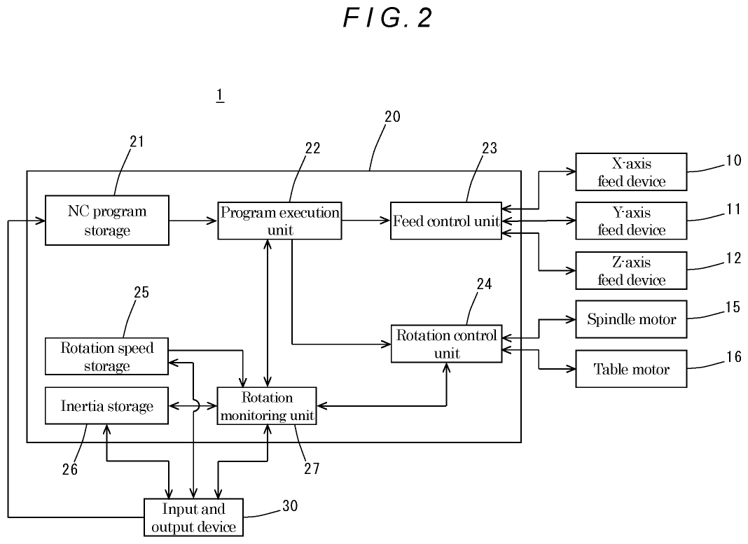

As illustrated in FIGS. 1 and 2, a machine tool 1 according to this embodiment is a horizontal machining center. The machine tool 1 has a bed 2, a column 3 erected on the bed 2, a table 4 arranged on the bed 2, a spindle head 5 held by the column 3, a spindle 6 rotatably supported by the spindle head 5, a controller 20, and an input and output device 30. Needless to say, the present invention is not limited to application to a machine tool having such a structure and can be applied to various types of machine tools, such as a vertical machining center, a lathe, and a combined machine tool capable of turning and milling.

A workpiece W is to be placed on the top of the table 4. The table 4 is driven by a Y-axis feed device 11 to move in a direction of Y-axis as a horizontal axis and is driven by an X-axis feed device 10 to move in a direction of X-axis as a horizontal axis orthogonal to the Y-axis. Further, the table 4 is driven by a table motor 16 to rotate about a vertical axis of rotation.

The spindle head 5 is driven by a Z-axis feed device 12 to move in a direction of Z-axis as a vertical axis orthogonal to the X-axis and the Y-axis. A tool T is to be attached to the distal end of the spindle 6. The spindle 6 is driven by a spindle motor 15 to rotate about a horizontal axis of rotation.

The operations of the X-axis feed device 10, Y-axis feed device 11, Z-axis feed device 12, spindle motor 15, and table motor 16 are controlled by the controller 20.

In this machine tool 1, under control by the controller 20, the workpiece W is machined by the tool T by moving the table 4 and the workpiece W in the X-axis and Y-axis directions through the X-axis feed device 10 and the Y-axis feed device 11 with rotation of the table 4 stopped and moving the spindle 6 and the tool T in the Z-axis direction through the Z-axis feed device 12 with the spindle 6 and the tool T being rotated by the spindle motor 15. Further, the workpiece W is turned by the tool T by moving the table 4 and the workpiece W in the X-axis and Y-axis directions through the X-axis feed device 10 and the Y-axis feed device 11 with the table 4 being rotated and moving the spindle 6 and the tool T in the Z-axis direction through the Z-axis feed device 12 with rotation of the spindle 6 stopped.

In the machine tool 1 according to this embodiment, the table 4, the X-axis feed device 10, the Y-axis feed device 11, the table motor 16, the spindle head 5, the spindle 6, and the Z-axis feed device 12 constitute a motion mechanism unit. Further, the tool T, a rotating part of the spindle 6, and a rotating part of the spindle motor 15 constitute a spindle rotary body, while the workpiece W, a rotating part of the table 4, and a rotating part of the table motor 16 constitute a table rotary body.

The input and output device 30 has a display, which is, for example, composed of a touch panel, and an input and output interface for inputting and outputting data, etc. Needless to say, the display is used to display an image, text information, etc. thereon and is capable of input through a display unit thereof.

As illustrated in FIG. 2, the controller 20 includes an NC program storage 21, a program execution unit 22, a feed control unit 23, a rotation control unit 24, a rotation speed storage 25, an inertia storage 26, and a rotation monitoring unit 27. The controller 20 is composed of a computer including a CPU, a RAM, and a ROM and appropriately configured electric circuit and electronic circuit or the like. The program execution unit 22, the feed control unit 23, the rotation control unit 24, and the rotation monitoring unit 27 are functionally implemented by a computer program and the electric circuit and electronic circuit or the like to execute the process described later. The NC program storage 21, the rotation speed storage 25, and the inertia storage 26 are composed of an appropriate storage medium such as a RAM.

The NC program storage 21 is a functional unit that stores NC programs (machining programs) for NC control. The NC program storage 21 stores, for example, an NC program input through the input and output device 30.

The program execution unit 22 sequentially reads the constituent blocks of an NC program to be executed selected from among the NC programs stored in the NC program storage 21 and processes an NC code contained in each block. In particular, when processing an NC code for feed control, the program execution unit 22 generates a control signal for the NC code and transmits the control signal to the feed control unit 23. When processing an NC code for rotation control, the program execution unit 22 generates a control signal for the NC code and transmits the control signal to the rotation control unit 24.

The feed control unit 23 is a functional unit that controls the operations of the X-axis feed device 10, Y-axis feed device 11, and Z-axis feed device 12. Upon receiving a control signal for feed control from the program execution unit 22, the feed control unit 23 controls the corresponding one of the X-axis feed device 10, Y-axis feed device 11, and Z-axis feed device 12 such that it operates at a speed corresponding to the received control signal.

The rotation control unit 24 is a functional unit that controls the rotating operations of the spindle motor 15 and table motor 16. Upon receiving a control signal for rotation control from the program execution unit 22, the rotation control unit 24 rotates the corresponding one of the spindle motor 15 and the table motor 16 with a rotation direction and a rotation speed corresponding to the received control signal.

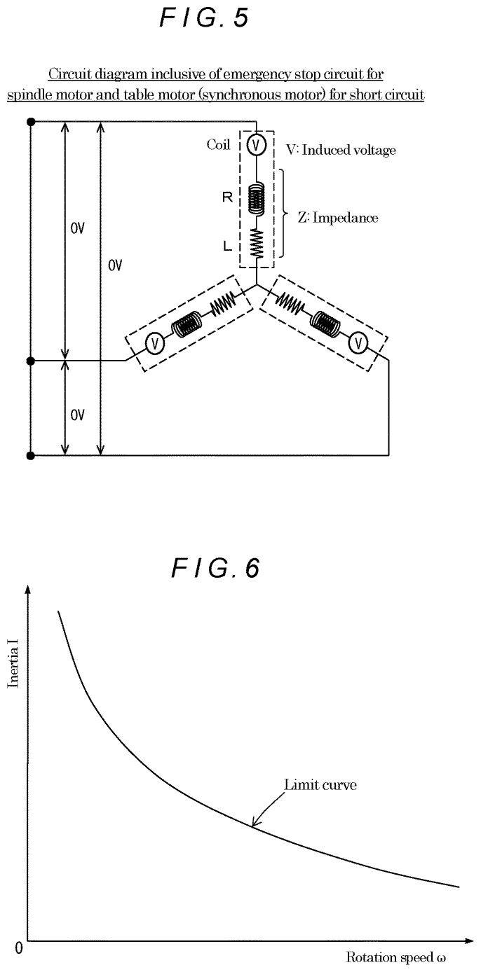

The rotation control unit 24 includes emergency stop circuits for carrying out emergency stopping of the spindle motor 15 and the table motor 16 when the electricity supply to the spindle motor 15 and the table motor 16 is interrupted due to power outage or any other cause. These emergency stop circuits are respectively provided with respect to the spindle motor 15 and the table motor 16. These emergency stop circuits are respectively connected to the spindle motor 15 and the table motor 16 in the event of interruption of the electricity supply to form a short circuit as illustrated in FIG. 5.

For instance, in the event of interruption of the electricity supply, the short circuit formed for the spindle motor 15 causes an induced current generated in the spindle motor 15 by idling of the spindle rotary body including the spindle motor 15 to flow into the coil, so that the rotational energy of the rotary body including the spindle motor 15 is converted into heat and thereby consumed (i.e., copper loss occurs). Thereby, the spindle motor 15 is stopped. The same applies to the table motor 16. In the event of interruption of the electricity supply, the short circuit formed for the table motor 16 causes an induced current generated in the table motor 16 by idling of the table rotary body including the table motor 16 to flow into the coil, so that the rotational energy of the rotary body including the table motor 16 is converted into heat and thereby consumed (i.e., copper loss occurs). Thereby, the table motor 16 is stopped.

Note that the emergency stop circuits are not limited to such a circuit and may be, for example, a short circuit which is configured to, in the event of interruption of the electricity supply, short-circuit a power line of the spindle motor 15 or table motor 16 and a power line of an amplifier for driving the spindle motor 15 or table motor 16 so as to cause electricity to be consumed using only an internal resistance of the spindle motor 15 or table motor 16.

The rotation speed storage 25 is a functional unit that stores an allowable rotation speed and a safe rotation speed set for the spindle rotary body constituted by the tool T, the rotating part of the spindle 6, and the rotating part of the spindle motor 15 and an allowable rotation speed and a safe rotation speed set for the table rotary body constituted by the workpiece W, the rotating part of the table 4, and the rotating part of the table motor 16. These allowable rotational speeds and safe rotational speeds are input through the input and output device 30 and stored into the rotation speed storage 25.

The allowable rotation speed is a preset rotation speed that is equal to or lower than a limit rotation speed as an upper limit rotation speed for (safely) stopping the idling motor 15, 16 through the corresponding emergency stop circuit before the motor 15, 16 burns out. The allowable rotation speed is set according to the inertia of each rotary body (the spindle rotary body and the table rotary body).

For instance, the allowable rotation speed set for the spindle rotary body including the spindle motor 15 is described here. The time tₛ [s] required to safely stop the spindle rotary body through the emergency stop circuit is calculated by Equation 1 below:

$${t}_{s} = {r}_{e} / {P}_{l o s s} , \qquad ( Equation 1 )$$

where rₑ [J] is the rotational energy of the spindle rotary body and Pₗₒₛₛ [J/s] is the copper loss in the emergency stop circuit.

The copper loss Pₗₒₛₛ [J/s] in the emergency stop circuit illustrated in FIG. 5 can be calculated by Equation 2 below:

$${P}_{l o s s} = 3 {RI}^{2} = R {▯ ( K ▯ ω )}^{2} / ( {R}^{2} + {( ω ▯ p ▯ L )}^{2} ) , \qquad ( Equation 2 )$$

where R is the resistance per phase [Ω], L is the inductance per phase [H], K is the line-to-line induced voltage constant [Vrms/(rad/s)], ω is the rotational angular speed [rad/s] (the rotational angular speed is equivalent to the rotation speed [m/s]; therefore, the rotational angular speed is referred to as “rotation speed” hereinafter), and p is the number of pole pairs (½ of the number of poles).

Further, the rotational energy rₑ can be represented by Equation 3 below:

$${r}_{e} = ( I ▯ {ω}^{2} ) / 2 , \qquad ( Equation 3 )$$

where I is the inertia [kgm²] of the spindle rotary body.

Accordingly, the time tₛ [s] can be represented by Equation 4 below:

$${t}_{s} = ( 1 ▯ {ω}_{2} ) / ( 2 ▯ {P}_{l o s s} ) . \qquad ( Equation 4 )$$

The Equation 4 above can be transformed into Equation 5 below. Thereby, a relationship between the inertia I of the spindle rotary body and the rotation speed (i.e., the limit rotation speed) ω for stopping the spindle rotary body in the time tₛ is obtained.

$$I = 2 ▯ {t}_{s} ▯ {P}_{l o s s} / {ω}^{2} \qquad ( Equation 5 )$$

The relationship between the inertia I of the spindle rotary body and the limit rotation speed ω can be represented by a limit curve as shown in FIG. 6. The rotation speed ω as situated below the limit curve with respect to the inertia I of the spindle rotary body allows the emergency stopping of the spindle rotary body to be safely carried out. The rotation speed ω as situated above the limit curve with respect to the inertia I of the spindle rotary body does not allow the spindle rotary body to be safely stopped.

The allowable rotation speed for the spindle rotary body is previously set according to the inertia I of the spindle rotary body based on the thus-obtained limit rotation speed corresponding to the inertia I of the spindle rotary body so that it is equal to or lower than the limit rotation speed. The thus-set allowable rotation speed and the inertia of the spindle rotary body are associated with each other and stored in the form of a data table into the rotation speed storage 25. The same applies to the table rotary body including the table motor 16. The set allowable rotation speed and the inertia of the table rotary body are associated with each other and stored in the form of a data table into the rotation speed storage 25.

Note that the inertia I [kgm²] of each rotary body can be calculated by Equation 6 below:

$$I = ( 2 {P}_{m o t o r} ▯ {t}_{a c} ) / {ω}^{2} , \qquad ( Equation 6 )$$

where t_{ac} [s] is the acceleration time of the motor 15, 16, Pₘₒₜₒᵣ [w] is the output during acceleration of the motor 15, 16, and ω [rad/s] is the rotation speed.

The safe rotation speed is a rotation speed having a sufficient margin such that the emergency stopping of the motor 15, 16 by the emergency stop circuit is safely carried out even when the inertia of the spindle rotary body or table rotary body is not known. The safe rotation speed is empirically set for each of the spindle rotary body and table rotary body and stored into the rotation speed storage 25.

The inertia storage 26 is a functional unit that stores the inertia of the spindle rotary body and the inertia of the table rotary body. Where these inertias are known, the values thereof are input through the input and output device 30 and stored into the inertia storage 26.

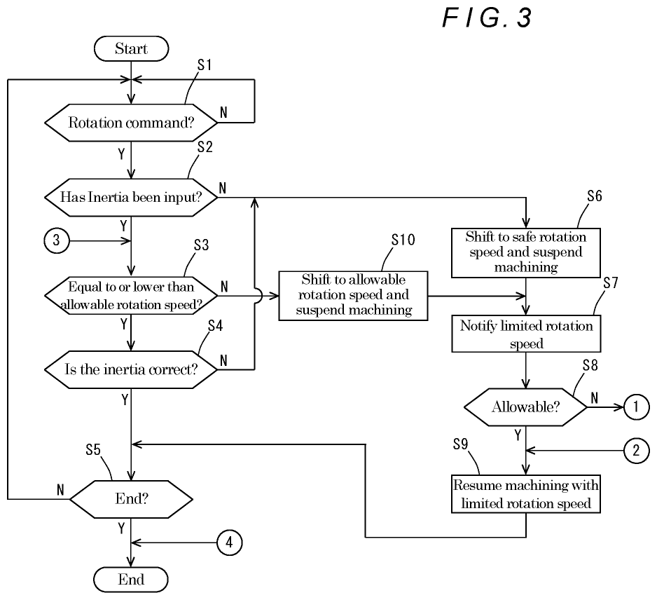

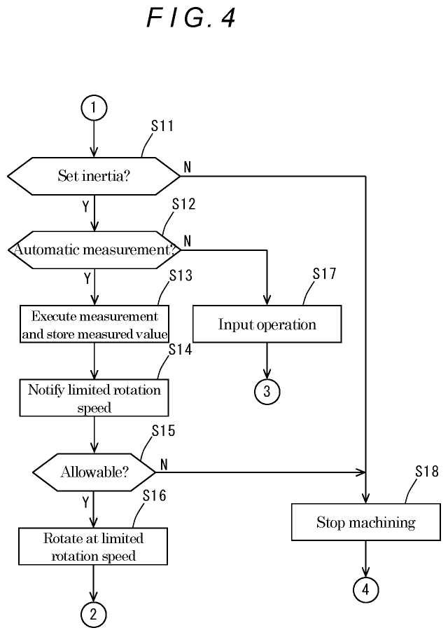

The rotation monitoring unit 27 comes into operation in response to the process in the program execution unit 22 being started. The rotation monitoring unit 27 executes the process shown in FIGS. 3 and 4. Specifically, once the process in the program execution unit 22 is started, the rotation monitoring unit 27 first receives an NC code to be processed from the program execution unit 22 and recognizes (monitors) whether or not the received NC code relates to a rotation command (step S1). There are a rotation command for the spindle motor 15 and a rotation command for the table motor 16. The process for the spindle motor 15 is described representatively below; however, the same applies to the table motor 16. Note that the process for the table motor 16 is described in parentheses below.

When a rotation command for the spindle motor 15 (the table motor 16) is confirmed in the step S1, the rotation monitoring unit 27 refers to the inertia storage 26 to confirm whether or not data on the inertia of the spindle rotary body (the table rotary body) is stored in the inertia storage 26 (step S2). When the data on the inertia is stored, the rotation monitoring unit 27 refers to the rotation speed storage 25 to check the allowable rotation speed set with respect to the inertia and determine whether or not the commanded rotation speed is equal to or lower than the allowable rotation speed (step S3).

On the other hand, when it is confirmed in the step S2 that the data on the inertia is not stored, the rotation monitoring unit 27 reads out the safe rotation speed stored in the rotation speed storage 25 and transmits a control signal corresponding to the safe rotation speed to the rotation control unit 24, thereby causing the rotation control unit 24 to shift the rotation speed of the spindle motor 15 (the table motor 16) to the safe rotation speed. Further, the rotation monitoring unit 27 instructs the program execution unit 22 to suspend the processing of the NC program, i.e., to suspend the machining (step S6). Thereafter, the rotation monitoring unit 27 proceeds to step S7.

When it is determined in the step S3 that the commanded rotation speed is not equal to or lower than the allowable rotation speed, the rotation monitoring unit 27 transmits a control signal corresponding to the allowable rotation speed to the rotation control unit 24, thereby causing the rotation control unit 24 to shift the rotation speed of the spindle motor 15 (the table motor 16) to the allowable rotation speed. Further, the rotation monitoring unit 27 instructs the program execution unit 22 to suspend the processing of the NC program, i.e., to suspend the machining (step S10). Thereafter, the rotation monitoring unit 27 proceeds to step S7.

On the other hand, when it is determined in the step S3 that the commanded rotation speed is equal to or lower than the allowable rotation speed, the rotation monitoring unit 27 estimates the inertia of the spindle rotary body based on the actual driving power of the spindle motor 15 (the table motor 16) and determines based on the estimated inertia whether or not the inertia of the spindle rotary body (the table rotary body) stored in the inertia storage 26 is correct (step S4). When it is correct, the rotation monitoring unit 27 repeatedly executes the operations in the step S1 and subsequent steps until receiving a process end signal from the program execution unit 22 (step S5). That is to say, the rotation monitoring unit 27 executes the operations in the step S1 and subsequent steps every time receiving a rotation command from the program execution unit 22. On the other hand, when it is determined that the stored inertia is erroneous, the rotation monitoring unit 27 proceeds to the step S6.

Note that the inertia of the spindle rotary body (the table rotary body) can be calculated (estimated) by the Equation 6 above. The rotation monitoring unit 27 obtains the actual acceleration time t_{ac} [s] and output during acceleration Pₘₒₜₒᵣ [w] of the spindle motor 15 (the table motor 16) from the rotation control unit 24 to estimate the inertia of the spindle rotary body (the table rotary body).

In step S7, the rotation monitoring unit 27 executes an operation of displaying the limited rotation speed on the display of the input and output device 30 to confirm with an operator whether to accept the limited rotation speed and resume the machining. When the operator selects through the display to accept the limited rotation speed and resume the machining (step S8), the rotation monitoring unit 27 transmits a machining resume signal to the program execution unit 22 with the rotation speed limited, thereby causing the program execution unit 22 to resume the machining (step S9). Thereafter, the rotation monitoring unit 27 proceeds to the step S5.

On the other hand, when the operator selects through the display in the step S8 not to accept the limited rotation speed, the rotation monitoring unit 27 confirms with the operator through the display whether to newly set the inertia of the spindle rotary body (the table rotary body) (step S11). When the operator selects through the display to newly set the inertia, the rotation monitoring unit 27 further confirms with the operator through the display whether to automatically measure the inertia (step S12).

When the operator selects through the display in the step S12 to newly automatically measure the inertia, the rotation monitoring unit 27 carries out automatic measurement of the inertia (step S13). The rotation monitoring unit 27 can carry out the automatic measurement by transmitting a stop signal to the rotation control unit 24 to suspend the rotation of the spindle motor 15 (the table motor 16) and then transmitting, for example, a control signal for rotating the spindle motor 15 (the table motor 16) at the safe rotation speed to rotate the spindle motor 15 (the table motor 16) at the safe rotation speed. Based on the actual acceleration time and output during acceleration of the spindle motor 15 (the table motor 16) obtained from the rotation control unit 24 in this process as well as the safe rotation speed, the inertia can be calculated by the Equation 6 above. Note that repeating this automatic measurement and averaging the data obtained will provide a more accurate inertia. The rotation monitoring unit 27 stores data on the calculated inertia into the inertia storage 26 (step S13).

Subsequently, the rotation monitoring unit 27 refers to the inertia storage 26 to recognize the allowable rotation speed corresponding to the calculated inertia, and executes the operation of displaying the recognized allowable rotation speed on the display to confirm with the operator whether to accept the allowable rotation speed and resume the machining (step S14). When the operator selects through the display to accept the allowable rotation speed and resume the machining, the rotation monitoring unit 27 transmits a control signal for the allowable rotation speed to the rotation control unit 24, thereby causing the rotation control unit 24 to rotate the spindle motor 15 at the allowable rotation speed (step S16). Thereafter, the rotation monitoring unit 27 proceeds to the step S9 to cause the program execution unit 22 to resume the machining.

On the other hand, when the operator selects through the display in the step S11 not to newly set the inertia and when the operator selects through the display in the step S15 not to accept the allowable rotation speed, the rotation monitoring unit 27 transmits a machining stop signal to the program execution unit 22 (step S18). Thereafter, the rotation monitoring unit 27 ends the process.

When the operator selects through the display in the step S12 not to automatically measure the inertia, in other words, to manually input the inertia, the rotation monitoring unit 27 accepts input of the inertia through the display and stores data on the input inertia into the inertia storage 26 (step S17). Thereafter, the rotation monitoring unit 27 executes the operations in the step S3 and subsequent steps.

In the machine tool 1 according to this embodiment having the above-described configuration, an NC program is executed by the program execution unit 22. Based on control signals from the program execution unit 22, the X-axis feed device 10, the Y-axis feed device 11, and the Z-axis feed device 12 are controlled by the feed control unit 23, while the spindle motor 15 and the table motor 16 are controlled by the rotation control unit 24. Thus, the X-axis feed device 10, the Y-axis feed device 11, the Z-axis feed device 12, the spindle motor 15, and the table motor 16 operate so that the workpiece W is machined by the tool T.

The control of the rotations of the spindle motor 15 and table motor 16 by the rotation control unit 24 based on the control signals from the program execution unit 22 is monitored by the rotation monitoring unit 27.

Specifically, every time the program execution unit 22 processes a rotation command, the rotation monitoring unit 27 confirms whether or not the inertia of the rotary body (the spindle rotary body or the table rotary body) corresponding to the rotation command is known (step S2). When the inertia is known, the rotation monitoring unit 27 determines whether or not the rotation command is equal to or lower than the allowable rotational speed set with respect to the inertia (step S3). When it is equal to or lower than the allowable rotational speed, the machining is continued. Therefore, in the event that the motor (the spindle motor 15 or the table motor 16) driving the rotary body becomes uncontrollable due to power outage or any other cause, the motor 15, 16 is safely stopped by the emergency stop circuit provided in the rotation control unit 24 without burning out. Further, performing the machining with such a rotation speed avoids excessive loading on the motor 15, 16 in driving and stopping the rotary body.

Further, the rotation monitoring unit 27 is configured to, when the rotation command is equal to or lower than the allowable rotational speed set with respect to the inertia, compare the known inertia stored in the inertia storage 26 with the inertia estimated by actual rotation of the motor to determine whether or not the known inertia is correct (step S4); as a result, the machining is continued with the rotation speed unchanged only when the known inertia is correct. Therefore, the machining is prevented from being continued with the rotation speed of the motor 15, 16 set at a critical speed due to an erroneous input of the inertia.

Further, the rotation monitoring unit 27 is configured to limit the rotation speed of the motor 15, 16 to the safe rotation speed when the inertia is not known (step S6) and to limit the rotation speed of the motor to the allowable rotation speed when the rotation command exceeds the allowable rotation speed set according to the inertia (step S10). Therefore, the motor is safely stopped by the emergency stop circuit without burning out in the emergency stopping.

Further, the rotation monitoring unit 27 is configured to suspend the machining when the inertia is not known and when the rotation command exceeds the allowable rotation speed set according to the inertia (step S6 and step S10) and to resume the machining with the limited rotation speed when the operator accepts the limited rotation speed (steps S7 to S9). With the rotation speed limited, it is possible that a target machining accuracy, such as in surface roughness, is not achieved. However, confirming with the operator whether or not the machining can be performed with the limited rotation speed will prevent a machined product from being defective.

Further, the rotation monitoring unit 27 is configured to be capable of automatic measurement of the inertia of the rotary body and capable of manual input of the inertia of the rotary body (steps S11 to S13 and S17). This realizes flexible setting of the inertia of the rotary body.

The machine tool 1 according to this embodiment achieves the above-described effects. The monitoring by the machining monitoring unit 27 in this embodiment is useful especially for first time execution of an NC program. This is because of the following reasons: in first time execution of an NC program, it may be unclear whether the inertia of each rotary body is appropriately set, and further each commanded rotation speed may exceed the limit rotation speed set according to the inertia of the corresponding rotary body since it is set so as to satisfy a machining time and a machining accuracy.

Above has been described an embodiment of the present invention. However, it should be noted that the present invention is not limited to the above-described embodiment and can be implemented in other manners.

For example, the machine tool 1 in the above-described embodiment has both the spindle rotary body including the spindle motor 15 and the table rotary body including the table motor 16. However, the present invention is not limited to a machine tool having such a configuration and may be applied to a machine tool having either one of the spindle rotary body and table rotary body or a machine tool having a completely different rotary body.

As already mentioned above, the foregoing description of the embodiments is not limitative but illustrative in all aspects. One skilled in the art would be able to make variations and modifications as appropriate. The scope of the invention is not defined by the above-described embodiments, but is defined by the appended claims. Further, the scope of the invention encompasses all modifications made from the embodiments within a scope equivalent to the scope of the claims.

### REFERENCE SIGNS LIST

1 Machine tool
2 Bed
3 Column
4 Table
5 Spindle head
6 Spindle
10 X-axis feed device
11 Y-axis feed device
12 Z-axis feed device
15 Spindle motor
16 Table motor
20 Controller
21 NC program storage
22 Program execution unit
23 Feed control unit
24 Rotation control unit
25 Rotation speed storage
26 Inertia storage
27 Rotation monitoring unit
30 Input and output device

1. A machine tool comprising:
a motion mechanism unit including a rotary body to be controlled; and
a controller configured to control at least a rotating operation of the rotary body in accordance with a machining program, wherein:
the controller is configured to: check data on an inertia of the rotary body when rotating the rotary body in accordance with the machining program; when the data on the inertia of the rotary body has been set, check whether or not a rotation speed of the rotary body specified by the machining program is equal to or lower than a limit rotation speed set according to the inertia of the rotary body; and when the rotation speed of the rotary body specified by the machining program exceeds the limit rotation speed, limit the rotation speed of the rotary body specified by the machining program using as an allowable rotation speed a preset rotation speed equal to or lower than the limit rotation speed;
the controller is further configured to, when the data on the inertia of the rotary body has not been set or when the set data on the inertia of the rotary body is determined to be an abnormal value, limit the rotation speed of the rotary body specified by the machining program to a preset safe rotation speed.

2. The machine tool according to claim 1, wherein the controller is configured to: confirm whether or not an operator accepts the allowable rotation speed; when the operator accepts the allowable rotation speed, continue machining by limiting the rotation speed of the rotary body specified by the machining program to the allowable rotation speed; and when the operator does not accept the allowable rotation speed, stop the machining.

3. (canceled)

4. The machine tool according to claim 1, wherein the controller is configured to: confirm whether or not an operator accepts the safe rotation speed; when the operator accepts the safe rotation speed, continue machining by limiting the rotation speed of the rotary body specified by the machining program to the safe rotation speed; and when the operator does not accept the safe rotation speed, stop the machining.

5. The machine tool according to claim 1, wherein the controller is configured to be capable of newly setting the data on the inertia of the rotary body when the data on the inertia of the rotary body has not been set or when the set data on the inertia of the rotary body is determined to be an abnormal value.

6. The machine tool according to claim 5, wherein the controller is configured to calculate and set the data on the inertia of the rotary body by causing the rotary body to perform the rotating operation and a stopping operation.

7. The machine tool according to claim 2, wherein the controller is configured to: confirm whether or not an operator accepts the safe rotation speed; when the operator accepts the safe rotation speed, continue machining by limiting the rotation speed of the rotary body specified by the machining program to the safe rotation speed; and when the operator does not accept the safe rotation speed, stop the machining.

8. The machine tool according to claim 2, wherein the controller is configured to be capable of newly setting the data on the inertia of the rotary body when the data on the inertia of the rotary body has not been set or when the set data on the inertia of the rotary body is determined to be an abnormal value.

9. The machine tool according to claim 4, wherein the controller is configured to be capable of newly setting the data on the inertia of the rotary body when the data on the inertia of the rotary body has not been set or when the set data on the inertia of the rotary body is determined to be an abnormal value.

10. The machine tool according to claim 7, wherein the controller is configured to be capable of newly setting the data on the inertia of the rotary body when the data on the inertia of the rotary body has not been set or when the set data on the inertia of the rotary body is determined to be an abnormal value.

11. The machine tool according to claim 8, wherein the controller is configured to calculate and set the data on the inertia of the rotary body by causing the rotary body to perform the rotating operation and a stopping operation.

12. The machine tool according to claim 9, wherein the controller is configured to calculate and set the data on the inertia of the rotary body by causing the rotary body to perform the rotating operation and a stopping operation.

13. The machine tool according to claim 10, wherein the controller is configured to calculate and set the data on the inertia of the rotary body by causing the rotary body to perform the rotating operation and a stopping operation.
